(19) United States
(12) Patent Application Publication
(10) Pub. No.: US 2009/0183708 A1
(43) Pub. Date: Jul. 23, 2009

(54) STARTING MODULE ASSEMBLY OF REMOTE CONTROL CAR

(76) Inventor: Jung-Yuang Liu, Taichung City (TW)

Correspondence Address: RABIN & Berdo, PC, 1101 14TH STREET, NW, SUITE 500, WASHINGTON, DC, 20005, US

(21) Appl. No.: 12/015,691

(22) Filed: Jan. 17, 2008

(51) Int. Cl. F02N 11/00; F01P 1/00; A63H 30/00

(52) U.S. Cl. 123/179.25; 123/41.56; 446/454

(57) ABSTRACT

A starting module assembly of a remote control car includes an engine mount and a starter. A seat cover and a fixed base are installed outside the engine mount. A transmission gear cylinder is installed between assembling holes of the seat cover and the fixed base. An actuation gear is engaged between two transmission gear cylinders and sheathed into a spindle bearing of the engine mount for switching the direction of directly installing the engine mount. The starter has a penetrating ventilation hole at the front end of the upper half portion for dissipating heat produced by the electric motor. An external cover for fixing the rechargeable battery is pivotally coupled for preventing the external cover from being separated or fallen off when the cover is lifted. Further, a space is reserved at the front end of the upper half portion for installing an electric motor of different sizes.

### BACKGROUND OF THE INVENTION

1. Field of the Invention

The present invention relates to a starting module assembly of a remote control car, for installing a transmission gear cylinder directly from both left and right sides of the engine mount when an engine mount is installed on either left or right side of a car body, and the front end of an upper half portion of a starter has a penetrating ventilation hole for timely dissipating hot air produced during the operation of an electric motor, and an external cover for fixing a rechargeable battery is pivotally coupled to a side, such that the cover will not be separated or fallen out when the cover is lifted, and a space is reserved at the interior of the front end of the upper half portion for installing an electric motor of different sizes, so as to achieve the practical effect of each starting module.

2. Description of the Related Art

At present, a starting module of a remote control car generally installs an engine mount B at a position under an engine A for the assembly (as shown in FIG. 1A), wherein a side cover C and a middle board D are installed on an external side of a one way bearing B1 of the engine mount B, and a driving gear E and a driven gear F are installed in the side cover C and engaged with each other, such that the driving gear E is installed in a through hole C1 next to the side cover C, and the driven gear F is installed on the one way bearing B1 of the engine mount B, and the driving gear E is coupled to the through hole C1 of the side cover C (as shown in FIG. 1B). After the driving gear E is actuated, the engaged driven gear F is rotated to drive the one way bearing B1 of the engine mount B to rotate and start the engine A.

However, it is found in practical applications that the engine mount B is installed on the left or right side depending on the requirements of the actual situation, and thus the original design of a left-side installation cannot fit the right-side installation. Similarly, the design of a right-side installation cannot fit the left-side installation. If it is necessary to switch the side for installation, related components are loosened, and the side of the design is adjusted, and then the related components are reinstalled. Such arrangement consumes much time, and makes the installation very inconvenient, particularly when the components are small in size.

Further, a transmission bearing H, a transmission gear and an electric motor are installed inside the front end of an upper half portion of a present commonly used starter G, and the electric motor is connected to a control switch I and a rechargeable battery J contained in a lower half portion to form a circuit, and then a tool K with the same shape of a through hole C1 is installed into the through hole C1 of a side cover C of an engine mount B, and the control switch I can be operated to start the operation of the electric motor, so as to start the operation of an engine A (as shown in FIG. 2A). However, the operation of the electric motor will produce heat which is generally not dissipated in time, and thus the electric motor may be busted easily after a certain time of use. Further, an external cover L used for fixing the position of the rechargeable battery J is isolated, and thus it is necessary to fix the upper section of the external cover L and then attach the lower section of the external cover L, and finally fix the whole external cover L from a latch G1 of a starter G. If the installation is improper during the process, then the aforementioned components will fall off easily (as shown in FIG. 2B), and thus such design is obviously not good enough. Further, if the power of the electric motor is insufficient, then a new starter is needed, and thus incurring extra expenses.

### SUMMARY OF THE INVENTION

In view of the foregoing shortcomings of the prior art, the inventor of the present invention developed a starting module assembly of a remote control car in accordance with the present invention to overcome the current technical problems.

Therefore, it is a primary objective of the present invention to provide a starting module assembly of a remote control car, and the assembly is comprised of an engine mount and a starter, and the engine mount is coupled to the bottom of the engine, and a fixed base is installed on an external side of a spindle bearing of the engine, and assembling holes with equal diameters are disposed on both sides of a center hole of the fixed base, and two transmission gear cylinders and an actuation gear are installed in the space of the base, and a seat cover is attached and fixed into the engine mount, and a transmission gear cylinder is installed separately on both left and right sides of the fixed base for driving the actuation gear to start an engine connected to the engine mount. Unlike the inconvenient installation of the prior art, the arrangement in accordance with the invention facilitates switching the direction of installing the engine mount and thus providing a quick and convenient installation directly.

Another objective of the present invention is to provide a starting module assembly of a remote control car, wherein the starter installs a transmission bearing, a transmission gear module and an electric motor in an internal space of the front end of an upper half portion, such that an electric motor is connected in series with a rechargeable battery contained in the lower half portion through a control switch to form a circuit, wherein a penetrating ventilation hole is disposed at the front end of the upper half portion, and an external cover for fixing the rechargeable battery is pivotally coupled on one side, so as to achieve practical application of each starting module.

Another objective of the present invention is to provide a starting module assembly of a remote control car, wherein the design of the penetrating ventilation hole disposed at the front end of the upper half portion of the starter can timely dissipate the heat produced by the operation of the electric motor.

Another objective of the present invention is to provide a starting module assembly of a remote control car, wherein the external cover disposed at the lower half portion of the starter for fixing the rechargeable battery is coupled on one side, such that the external cover will not fall off easily when the cover is lifted.

Another objective of the present invention is to provide a starting module assembly of a remote control car, wherein the design of reserving a space in the front end of the upper half portion of the starter allows the installation of an electric motor of a different size.

Another objective of the present invention is to provide a starting module assembly of a remote control car, wherein a handle is made in a wavy form and disposed at the rear end of the upper half portion of the starter and provided for users to handle securely, so that the starting module assembly will not fall off easily.

### BRIEF DESCRIPTION OF THE DRAWINGS

FIG. 1A is an exploded view of a prior art engine mount;

FIG. 1B is a schematic view of an assembled prior art engine mount;

FIG. 2 A is a perspective view of a prior art starter;

FIG. 2B is a schematic view of installing a starter, a rechargeable, a battery, and an external cover of a prior art;

FIG. 3 is an exploded view of an engine mount of the present invention;

FIG. 4A is a schematic view of an engine mount of the present invention;

FIG. 4B is another schematic view of an engine mount of the present invention;

FIG. 5 is a perspective view of a starter of the present invention;

FIG. 6A is a schematic view of a portion of a starter of the present invention;

FIG. 6B is a schematic view of another portion of a starter of the present invention;

FIG. 7A is an exploded view of an external cover of a rechargeable battery in a starter of the present invention;

FIG. 7B is a perspective view of an external cover of a rechargeable battery in a starter of the present invention;

FIG. 7C is a perspective view of an external cover of a rechargeable battery in a starter of the present invention;

FIG. 8A is a perspective view of a starter of the present invention;

FIG. 8B is another perspective view of a starter of the present invention;

FIG. 9A is a schematic view of a first preferred embodiment of the present invention; and

FIG. 9B is a schematic view of a second preferred embodiment of the present invention.

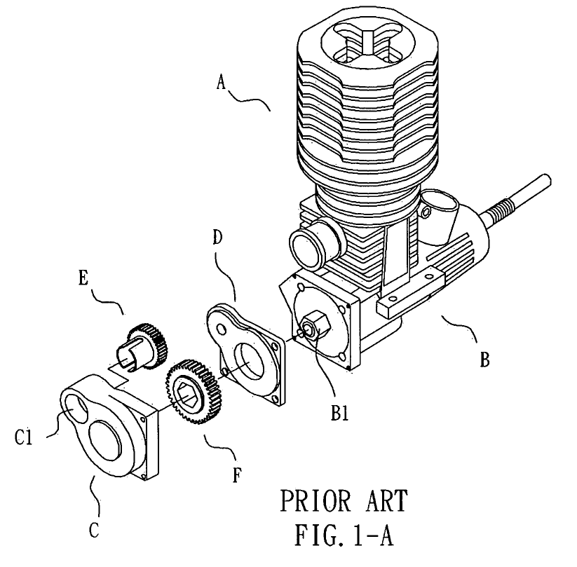

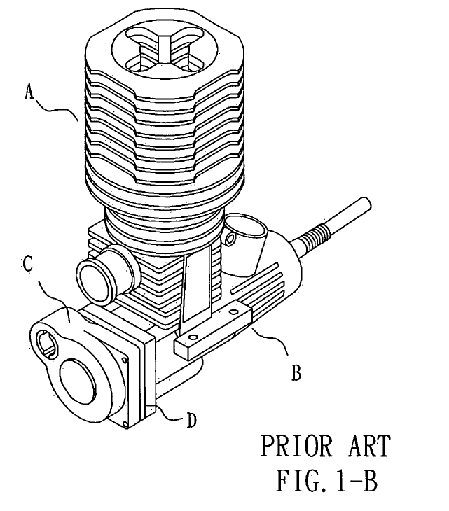

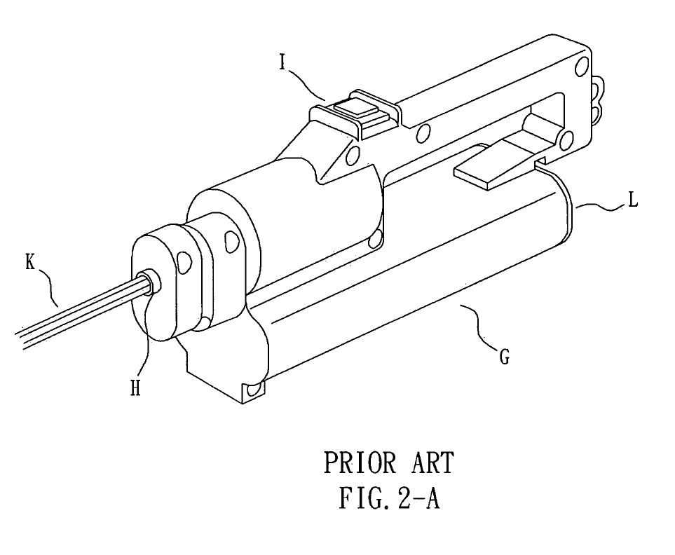

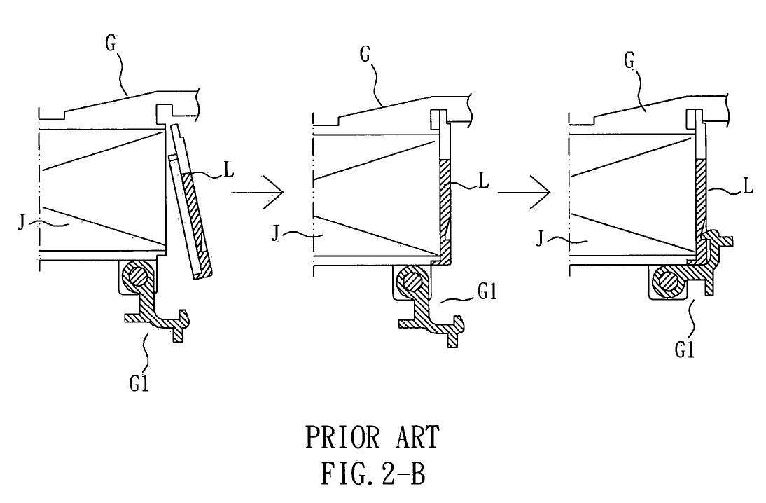

### DETAILED DESCRIPTION OF THE PREFERRED EMBODIMENTS

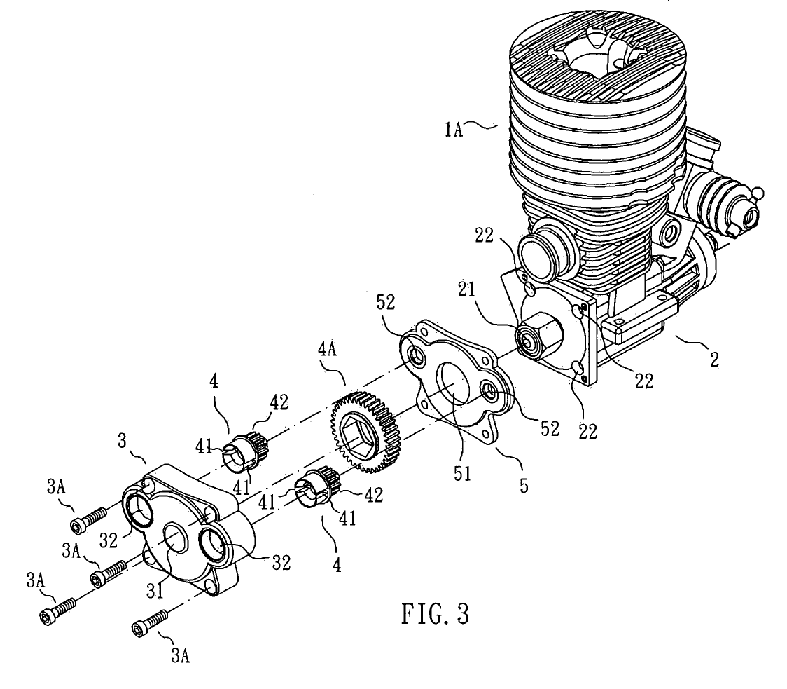

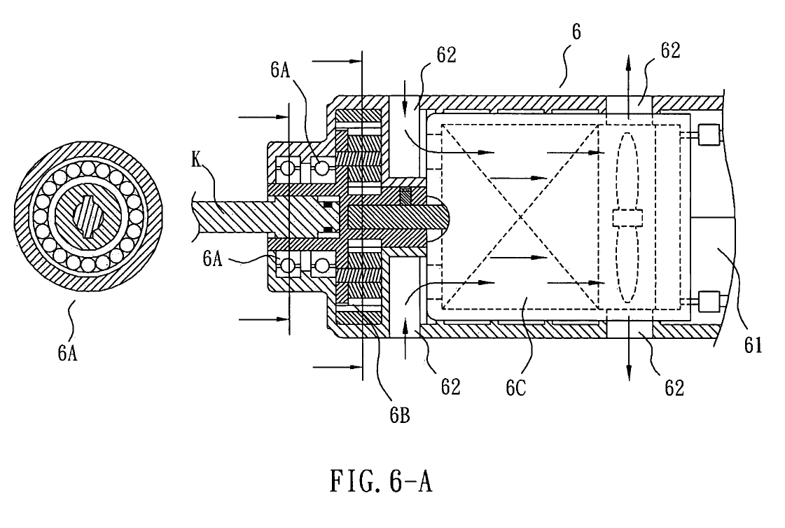

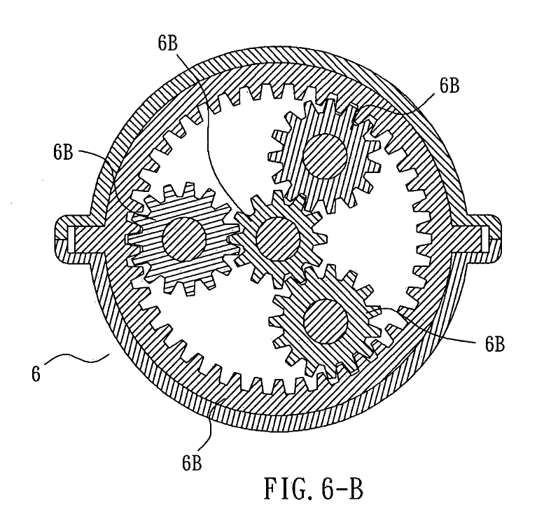

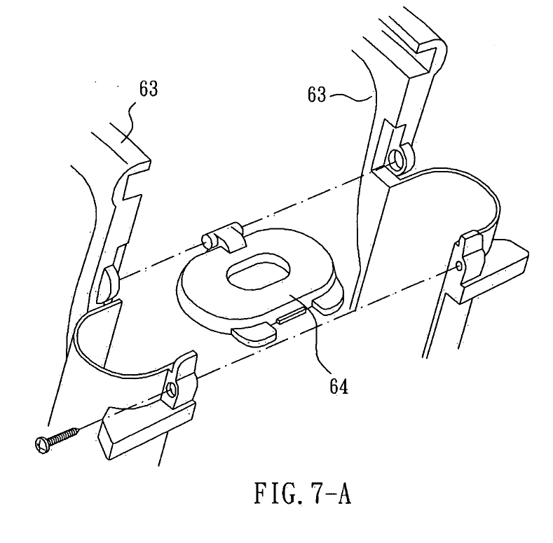

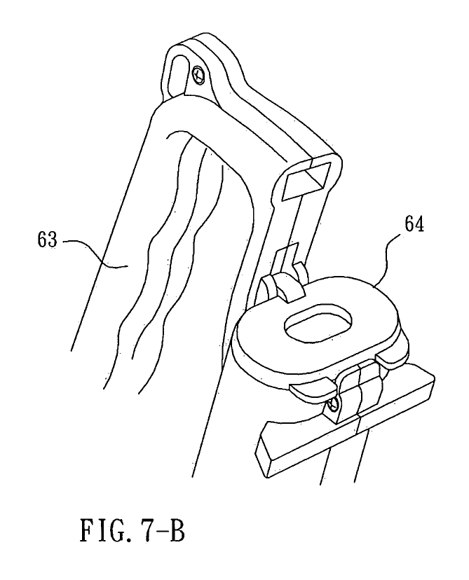

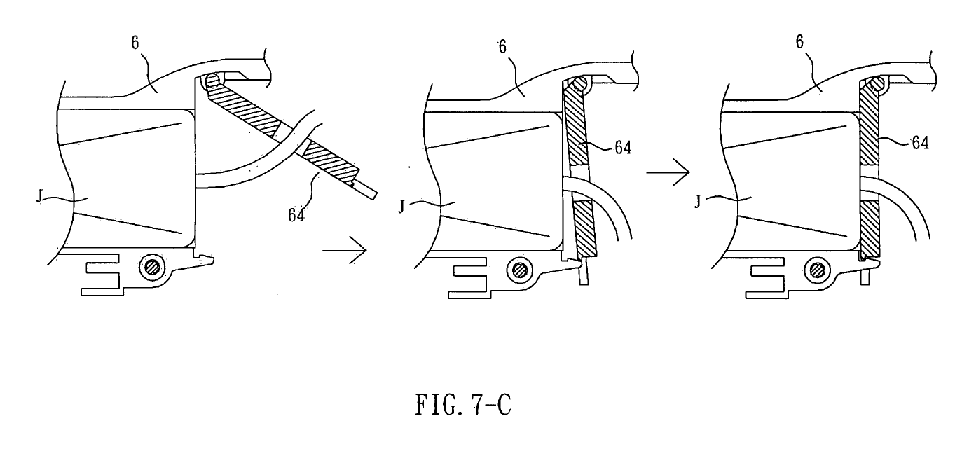

Referring to FIGS. 3, 4A, 4B, 5, 6A and 6B for the present invention, a starting module assembly of a remote control car comprises an engine mount 2 and a starter 6, and an engine mount 2 is connected to the bottom of an engine 1A in a car body 1, wherein a fixed base 3 is installed at a spindle bearing 21 of the engine mount 2, and assembling holes 32 with equal diameter are disposed respectively on both sides of a center hole 31 of the fixed base 3, and two transmission gear cylinders 4 are installed in the space inside the base, and the seat cover 5 with a shape corresponding to the fixed base 3 has a center hole 51 and assembling holes 52 disposed respectively on both sides of the center hole 51, and two transmission gear cylinders 4 are installed between the fixed base 3 and the seat cover 5, and an actuation gear 4A is engaged between the two transmission gear cylinders 4, wherein both sides of the transmission gear cylinder 4 have a dent 41 and a ring gear 42, and the dent 41 is aligned, passed and limited into the assembling hole 32, and the ring gear 42 is engaged with the actuation gear 4A, and a distal end of the ring gear 42 is sheathed into the assembling hole 52, and then the fixed base 3 is attached to the seat cover 5, and a bolt 3A outside the fixed base 3 is passed and fixed into a screw hole 22 of the engine mount 2 adjacent to the spindle bearing 21, and a transmission bearing 6A, a transmission gear module 6B and an electric motor 6C are installed in an internal space 61 at the front end of the upper half portion of the starter 6, and the electric motor 6C is connected in series with a rechargeable battery J contained in the lower half portion through a control switch 6D to form a circuit, wherein a penetrating ventilation hole 62 is disposed at the front end of the upper half portion, and a wavy handle 63 is made at the rear end of the upper half portion and provided for users to grip. An external cover 64 for fixing the rechargeable battery J is pivotally coupled on a side (as shown in FIGS. 7A and 7B) to facilitate installing the rechargeable battery J, and one side is pivotally coupled for lifting the cover, and thus the external cover 64 will not be separated or fallen off easily when the external cover 64 is lifted (as shown in FIG. 7C).

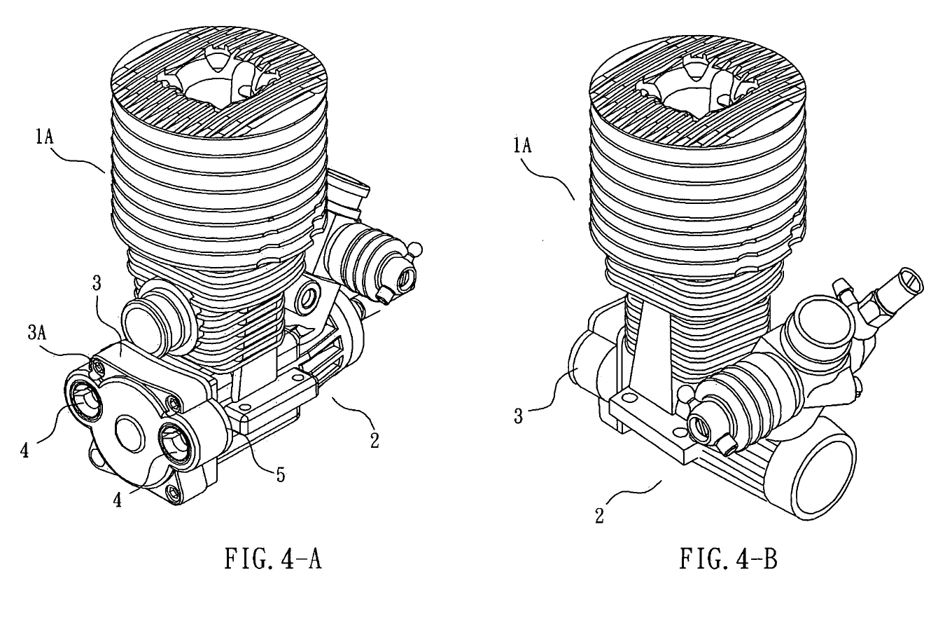

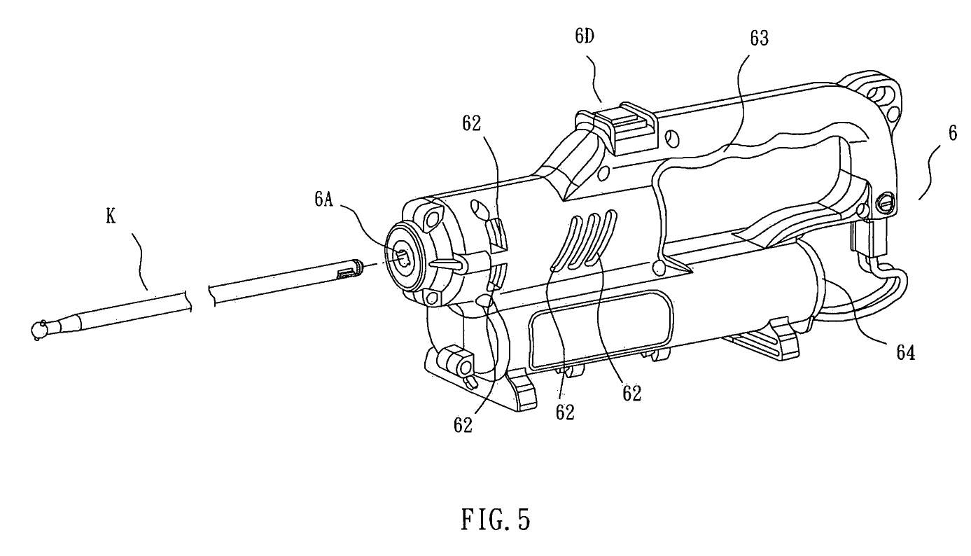

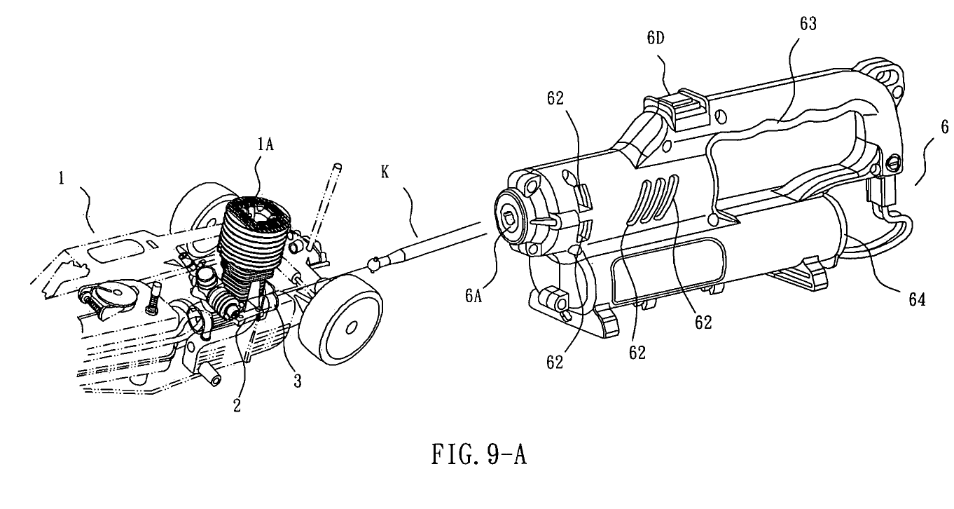

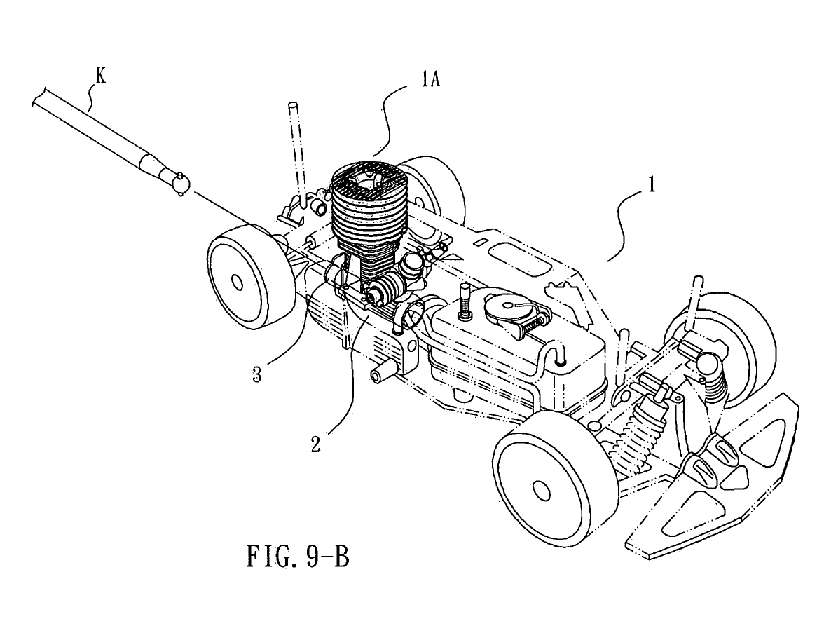

After the engine mount 2 (as shown in FIGS. 3 and 4A) and the starter 6 (as shown in FIGS. 5, 6A and 8A) are installed, the design of installing a transmission gear cylinder 4 separately on both left and right sides in the fixed base 3 can fit the situation of installing the engine 1A and the engine mount 2 on either left or right sides of the car body 1 (as shown in FIGS. 9A and 9B), and thus the invention can improve the inconvenient installation according to the prior art, so as to provide a direct, quick, and convenient installation without requiring the reinstallation process.

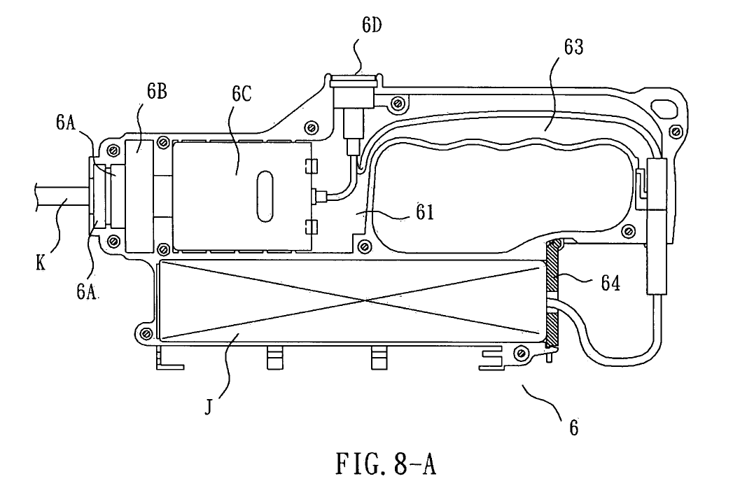

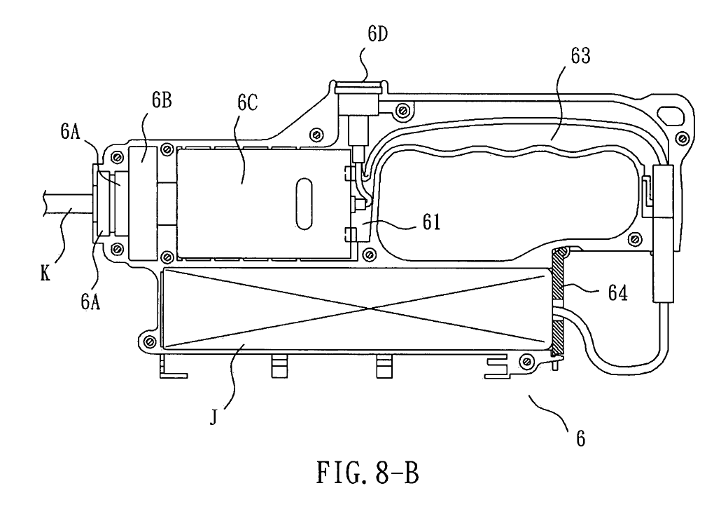

Further, if the transmission bearing 6A installed at the front end of the upper half portion of the starter 6 is installed by a tool K, the control switch 6D can be operated to drive the rechargeable battery J to supply electric power to the electric motor 6C and start the operation of the transmission gear module 6B, and the tool K is inserted into the assembling hole 32 of the fixed base 3 of the engine mount 2, such that the transmission gear cylinder 4 starts the actuation gear 4A to drive the operation of the spindle bearing 21 (as shown in FIGS. 9A and 9B). In addition, the penetrating ventilation hole 62 disposed at the front end of the upper half portion of the starter 6 can timely dissipate the heat produced by the operation of the electric motor 6C to maintain a smooth operation and extend the life of the motor. The wavy handle 63 disposed at the rear end of the upper half portion is provided for users to grip securely to prevent the assembly from falling off. The present invention further reserves an internal space 61 at the front end of the upper half portion of the starter 6 for installing an electric motor 6C of different powers and sizes (as shown in FIGS. 8A and 8B).

In summation of the description above, the present invention improves over the prior art, and complies with the requirements of patent application, and thus is duly filed for patent application.

What is claimed is:

1. A starting module assembly of a remote control car, comprising an engine mount and a starter, and the engine mount being coupled to the bottom of an engine, and a fixed base being installed on an external side of a spindle bearing of the engine, and assembling holes with equal diameters being disposed respectively on both sides of a center hole of the fixed base, and two transmission gear cylinders and an actuation gear being installed in a space inside the base, and a seat cover being attached and fixed into the installed engine mount, and a transmission gear cylinder being installed on both left and right sides in the fixed base and provided for driving the actuation gear to start the engine connected to the engine mount, so that the engine mount can be installed directly in a switched direction without requiring an inconvenient installation and reinstallation process of the prior art, so as to provide a direct, quick, convenient installation without the need of reinstallation.

2. A starting module assembly of a remote control car, comprising an engine mount and a starter, and the starter installing a transmission bearing, a transmission gear module, and the electric motor being installed in an internal space of an upper half portion and connected in series with to a rechargeable battery contained in the lower half portion through a control switch to form a circuit, wherein a penetrating ventilation hole is disposed at a front end of the upper half portion, and a wavy handle is made at a rear end of the upper half portion of the starter, and an external cover for fixing the rechargeable battery is pivotally coupled on a side, so as to achieve the practical starting effect.

3. The starting module assembly of a remote control car as recited in claim 2, wherein a penetrating ventilation hole is designed at the front end of the upper half portion of the starter for timely dissipating heat produced by the operation of the electric motor.

4. The starting module assembly of a remote control car as recited in claim 2, wherein the external cover disposed on the lower half portion of the starter for fixing the rechargeable battery is pivotally coupled on a side for prevent the external cover from being separated or falling off while lifting the external cover.

5. The starting module assembly of a remote control car as recited in claim 2, wherein a space is reserved in the front end of the upper half portion of the starter, for installing an electric motor of different powers and sizes.

6. The starting module assembly of a remote control car as recited in claim 2, wherein a wavy handle is made at a rear end of an upper half portion of the starter and provided for users to hold securely and prevent sliding off.
